(19) United States
(12) Patent Application Publication
(10) Pub. No.: US 2026/0338306 A1
(43) Pub. Date: Oct. 29, 2026

(54) CONNECTION SYSTEM FOR CONDUCTING FLUID, CORRESPONDING METHOD, CONNECTION ELEMENT, INSERTION PART AND COVER ELEMENT

(71) Applicant: NORMA GERMANY GMBH, Maintal (DE)

(72) Inventor: Cedric GALLOU, Guichen (FR)

(21) Appl. No.: 19/118,915

(22) PCT Filed: Sep. 28, 2023
(86) PCT No.: PCT/EP2023/076895

§ 371 Date: Apr. 7, 2025

(30) Foreign Application Priority Data
Oct. 7, 2022 (DE) 10 2022 126 011.9

(51) Int. Cl. F16L 37/12

(52) U.S. Cl. CPC F16L 37/1225

(57) ABSTRACT

A connection element for fluid-conducting connection to an insertion part. The connection element can include a main body and a securing system. The main body can include a fluid channel and a receptacle for receiving the insertion part. The securing system is arranged on the main body and is configured to secure the insertion part in the receptacle in a predefineable position relative to the fluid channel in order to provide a fluid-conducting connection between the connection element and the insertion part. The securing system can include a first securing element and a second securing element.

### INTRODUCTION

The disclosure relates to a connection element for the fluid-conducting connection to a plug-in part, a plug-in part, a connection system which comprises the connection element and the plug-in part, a method for the reversible provision of a fluid-conducting connection, and a covering element.

For the provision of a fluid-conducting connection for, for example, coolant in a vehicle, connections systems are known, for example, from DE 10 2004 062 887 B3, in which couplings are secured by way of single-piece securing elements on a plug-in part. Considerable effort which has to be provided by way of a tool is as a rule necessary in order to release a connection of this type.

Furthermore, in the case of a connection system with a single-piece securing element, a respective plug-in part has to be introduced exactly in a predefined position into the coupling, in order to ensure correct securing of the plug-in part in the coupling.

### SUMMARY

Against this background, it is an object per an embodiment to provide an option for the simple and reliable provision of a fluid-conducting connection.

Therefore, in accordance with an embodiment, a connection element for the fluid-conducting connection to a plug-in part is provided. The connection element comprises a main body and a securing system, wherein the main body comprises a fluid channel and a receptacle for receiving the plug-in part, wherein the securing system is arranged on the main body and is configured to secure the plug-in part in a predefined position relative to the fluid channel in the receptacle, in order to provide a fluid-conducting connection between the connection element and the plug-in part, wherein the securing system comprises a first securing element and a second securing element, wherein the first securing element can be moved between a lower position and an upper position, wherein the second securing element can be moved between an upper position and a lower position, wherein the second securing element is to be reversibly coupled or can be reversibly coupled mechanically to the first securing element via a number of coupling elements, wherein the number of coupling elements can be moved between a coupling position and a release position, wherein, in the coupling position, the number of coupling elements transmit a movement of the first securing element to the second securing element, with the result that the first securing element moves the second securing element in the direction of its lower position, in particular into its lower position, when, in the case of a movement of the plug-in part along a predefined trajectory through the main body, the pressure element of the plug-in part moves the first securing element into its lower position, and the number of coupling elements release a movement of the first securing element into its upper position when the pressure element moves along the predefined trajectory further through the main body into the second securing element.

In an embodiment, a receptacle for a plug-in part is to be understood to mean a recess in the main body of the proposed connection element, into which recess the plug-in part can be introduced, in particular plugged, with the result that the main body encloses the plug-in part at least in regions and, in particular, in a fluid-tight manner.

In an embodiment, an upper position of the first securing element is to be understood to mean a position of the first securing element, in which the first securing element partially overlaps the receptacle of the main body. Accordingly, an upper position of the first securing element is to be understood to mean a position which lies opposite the lower position, that is to say a position, in which the first securing element does not overlap the receptacle. In particular, the lower position of the first securing element is at the bottom in the direction of gravity, and the upper position of the first securing element is at the top in the direction of gravity. In particular, the first securing element is pressed into its upper position by optional spring elements.

In an embodiment, a lower position of the second securing element is to be understood to mean a position of the second securing element, in which the second securing element partially overlaps the receptacle of the main body. In particular, the lower position of the second securing element is at the bottom in the direction of gravity, and the upper position of the second The connection element per an embodiment is based on the principle that a plug-in part, introduced into the connection element, is secured in the connection element by way of a securing system which comprises two securing elements. Here, the two securing elements are separate components and can be moved relative to one another in at least one state of the connection element, with the result that they can be moved independently of one another at least temporarily at different times during a connection operation and, for example, the plug-in part can first of all be oriented in the connection element by way of the first securing element and subsequently can be fixed finally in the connection element by way of the second securing element.

Furthermore, the first securing element and the second securing element are or can be reversibly coupled mechanically to one another, with the result that a movement of the first securing element leads to a movement of the second securing element of the securing system. Here, the securing system is arranged in the main body in such a way that the second securing element can be moved in the direction of its lower position only when the first securing element is moved into its lower position by a plug-in part which moves through the main body or in the main body on a predefined trajectory, that is to say in a correctly predefined position or relative orientation with respect to the main body. Accordingly, the securing system secures the plug-in part in the main body only when the plug-in part is seated correctly or has been introduced into the main body in a correct or predefined position, with the result that an incorrect seat, possibly leading to a leak, of the plug-in part in the main body is prevented.

It can be provided that the first securing element comprises a number of spring elements which are configured to press the first securing element from its lower position into its upper position. Spring elements such as, for example, elastic arms bring about an automatic movement of the first securing element into an upper position by pressing against a wall of the main body.

It can be provided, furthermore, that the second securing element can be moved between its upper position, its lower position and an intermediate position when the plug-in part moves through the main body, wherein the second securing element is situated in its intermediate position between its upper position and its lower position and releases a movement of the plug-in part through the main body.

An intermediate position of the second securing element enables a release state, in which the receptacle of the main body is overlapped neither by the first securing element nor by the second securing element, with the result that the plug-in part can be removed from the main body.

It can be provided, furthermore, that the first securing element comprises adjacent arms which surround a receptacle of the main body, wherein a number of coupling elements are arranged on each of the arms, wherein the number of coupling elements can be moved between a release position and a coupling position, and the coupling elements are oriented toward one another in their coupling position, and are oriented further away from one another in the release position than in the coupling position, wherein the second securing element comprises a number of arms which each comprise a receptacle for engagement of a coupling element of the number of coupling elements of the first securing element, with the result that the number of coupling elements block a movement of the second securing element relative to the first securing element when the number of coupling elements are situated in their coupling position, and release a movement of the second securing element relative to the first securing element when the number of coupling elements are situated in their release position.

Coupling elements of the first securing element which interact with arms of the second securing element achieve a coupled or mutually coordinated movement of the first securing element and the second securing element, with the result that the first securing element moves relative to the second securing element or vice versa when the coupling elements are moved into their coupling position.

As soon as the coupling elements have moved into their release position, the first securing element and the second securing element can be moved independently of one another, with the result that, for example, the first securing element can be moved into its upper position while the second securing element is kept in its lower position.

It can be provided, furthermore, that the number of coupling elements overlap the receptacle in the first position, with the result that the plug-in part presses the number of coupling elements into the release position when the plug-in part engages into the receptacle.

An overlap of the receptacle by the coupling elements, that is to say an arrangement of the coupling elements in such a way that they protrude into a cross section of the receptacle or a spacing of the coupling elements is smaller than the cross section of the receptacle, brings it about that the coupling elements are pressed automatically into their release position by a plug-in part, the cross section of which corresponds substantially to the cross section of the receptacle, when the plug-in part is pressed into the receptacle.

It can be provided, furthermore, that the main body comprises a securing element receptacle for receiving the first securing element in regions, wherein the first securing element engages in regions into the securing element receptacle in its lower position, in order to release the receptacle of the main body, and overlaps the receptacle in regions in its upper position.

A securing element receptacle such as, for example, a recess in the main body makes a movement of the first securing element into the securing element receptacle possible, with the result that the first securing element can be introduced in regions into the securing element receptacle, and, in its lower position, the first securing element releases the receptacle of the main body in order to plug in a plug-in part or in order to pull out the plug-in part.

It can be provided, furthermore, that the second securing element can be moved between its upper position, an intermediate position and its lower position, and the second securing element comprises a number of transmission elements which are configured to transmit a pressure force, exerted on the second securing element, to the first securing element when the second securing element moves from its upper position into its intermediate position, in order to move the first securing element from its upper position, in which the first securing element overlaps the receptacle of the main body in regions, into its lower position, in which the first securing element releases the receptacle of the main body.

An intermediate position, in which the second securing element is situated in a position which is elevated in comparison with its lower position and a position which is lowered in comparison with its upper position and in which the number of transmission elements of the second securing element engage on the first securing element, makes a coupled or simultaneous (that is to say, synchronous) movement of the first securing element with the second securing element possible, with the result that a pressure on the second securing element moves both the first securing element and the second securing element downward, with the result that neither the first securing element nor the second securing element overlaps the receptacle of the main body, and a plug-in part which is arranged in the connection element can be removed from the connection element.

It can be provided, furthermore, that, in its lower position, the second securing element itself overlaps the receptacle of the main body in regions, and locking elements of the second securing element engage into locking element receptacles of the first securing element, in order to secure the first securing element in its lower position, wherein the second securing element is situated in its intermediate position in a position which is elevated in comparison with the lower position of the second securing element and in which the number of transmission elements of the second securing element engage on the first securing element and the locking elements are released from the locking element receptacles.

In particular, the locking element receptacles can be formed by spring elements of the first securing element, with the result that the locking elements of the second securing element prevent a spring action which presses the first securing element out of its lower position into its upper position when they engage into the locking element receptacles.

It can be provided, furthermore, that the second securing element comprises a number of first user interfaces for the manual movement of the second securing element from its lower position into an upper position and a number of user interfaces for the manual movement of the second securing element from its upper position into its intermediate position.

A user interface can be, for example, a material projection, a predefined material region or any further region, suitable for operation by user, of the connection element. In particular, user interfaces which are paired or are arranged so as to lie opposite one another can be provided, with the result that the user can grip and move, in particular pull, the second securing element with a pincer or tweezer grip.

It can be provided, furthermore, that a number of recesses are configured in the second securing element, through which recesses a number of display regions which are configured on the main body are visible when the second securing element is situated in its lower position, wherein a region, surrounding a respective recess, of the second securing element overlaps a respective display region when the second securing element is situated in its upper position.

Since the second securing element is situated in its lower position only when a plug-in part is secured in the main body, the second securing element conceals or overlaps the number of display regions in its upper position, with the result that the number of display regions cannot be seen visually. Accordingly, the second securing element releases the number of display regions, that is to say makes the number of display regions visually discernible when the second securing element is situated in its lower position.

When the second securing element is situated in its upper position, respective display regions are overlapped, that is to say concealed, by a material, surrounding the recesses, of the second securing element, with the result that the display regions are concealed and, in particular, machine-readable codes which are provided in the display regions cannot be detected by machine.

It can be provided, furthermore, that a machine-readable code is shown in respective display regions of the number of display regions.

A machine-readable code such as, for example, a QR code can encode or provide, for example, information about the connection system. Here, the position of the machine-readable code in a respective display region ensures that the machine-readable code can be read out or detected only when the second securing element is situated in its lower position, and a plug-in part is correspondingly secured in the main body. Accordingly, for the case where the machine-readable code is detected by machine, it can be assumed that the second securing element is situated in its lower position and a plug-in element is secured in the main body, with the result that a corresponding validation notification can be output, that is to say, for example, displayed on an output unit or stored in a memory.

In accordance with an embodiment, the disclosure relates to a plug-in part for the fluid-conducting connection to one possible embodiment of the connection element, wherein the plug-in part comprises a main body with a channel for conducting fluid and a multiplicity of pressure elements which are arranged on the main body, wherein the pressure elements are spaced apart from one another in such a way that the first securing element and the second securing element engage between two pressure elements of the multiplicity of pressure elements when the plug-in part is secured in the connection element, and wherein the plug-in part is configured, in the case of a movement on a predefined trajectory through the main body, to move the first securing element of the connection element into its lower position and, due to this, to move the second securing element into its lower position.

Pressure elements which engage around the first securing element and the second securing element, in particular in a positively locking manner, minimize a movement play of the plug-in part in the connection element.

Furthermore, pressure elements cause a movement of the first securing element and, due to this, a movement of the second securing element into their respective lower position when the plug-in part is plugged into the connection element.

In accordance with an embodiment, the disclosure relates to a connection system for conducting fluid. The connection system comprises a number of possible embodiments of the connection elements and a number of possible embodiments of the proposed plug-in part.

In accordance with an embodiment, the disclosure relates to a method for the reversible provision of a fluid-conducting connection. The connection method comprises providing one possible embodiment of the connection system, introducing a respective plug-in part into a receptacle of a respective connection element of the connection system, as a result of which the plug-in part in the connection element first of all presses the first securing element into its lower position and, due to a reversible mechanical coupling of the first securing element to the second securing element, presses the second securing element into its lower position, and, on its trajectory through the connection element, the plug-in part releases the reversible mechanical coupling, with the result that the first securing element moves into its upper position on account of a spring force which is provided by spring elements of the first securing element, while the second securing element remains in its lower position, wherein the first securing element overlaps the receptacle in regions in its upper position, and the second securing element overlaps the receptacle in regions in its lower position, in order to secure the plug-in part in the connection element.

It can be provided that the method comprises, furthermore moving the second securing element into its upper position, and moving the second securing element out of its upper position into its intermediate position in the direction of the main body, with the result that the first securing element is pressed into its lower position via a number of transmission elements of the second securing element, without the second securing element overlapping the receptacle of the main body.

In accordance with an embodiment, the disclosure relates to a covering element for selectively covering a display region on a main body of one possible embodiment of the proposed connection element.

The covering element comprises a covering body, an interface for mechanical coupling to the second securing element of the connection element and a number of recesses which are configured in the covering body, wherein the covering element is configured to also move in the case of a movement of the second securing element, with the result that, when the second securing element is situated in its lower position, display regions which are configured on the main body can be detected by machine, and the covering body overlaps a respective display region of the main body when the second securing element is situated in its upper position.

### BRIEF DESCRIPTION OF THE FIGURES

Further features, details and advantages of the invention result from the wording of the claims and from the following description of exemplary embodiments using the drawings, in which:

FIG. 1 shows a cross section through one possible embodiment of the connection system in a

FIG. 2 shows a detailed view of one possible embodiment of a securing system of the connection system according to FIG. 1,

FIG. 3 shows a sequence of a movement of a securing system of the connection system according to FIG. 1 during plugging in of a plug-in element,

FIG. 4 shows the connection system according to FIG. 1 with a plugged in plug-in element,

FIG. 5 shows one possible embodiment of the method, in which a connection which is provided by way of the connection system according to FIG. 1 is released,

FIG. 6 shows a further possible embodiment of the securing system provided with a covering element, and

FIG. 7 shows a further possible embodiment of the connection system with the securing system according to FIG. 6.

### DETAILED DESCRIPTION

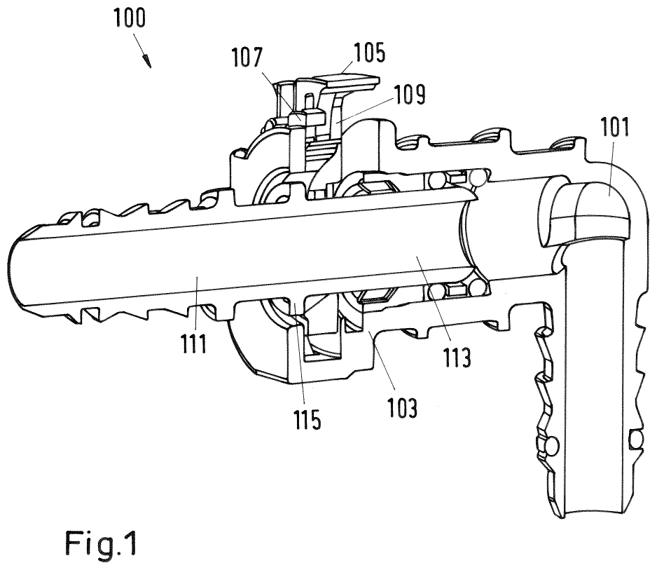

FIG. 1 shows a connection system 100. The connection system 100 comprises a connection element 101 which comprises a main body 103 and a securing system 105, consisting of a first securing element 107 and a second securing element 109, and a plug-in part 111.

In a basic state, that is to say without a plug-in part 111 introduced into the connection element 101, the first securing element 107 is situated in its upper position due to a spring force which is provided by spring elements (not shown here) of the first securing element 107, and is coupled mechanically to the second securing element 109 via coupling elements (likewise not shown here), with the result that the first securing element 107 likewise presses the second securing element 109 into its upper position.

When the plug-in part 111 is plugged or pressed into a receptacle 113 which is formed in the main body 103, the first securing element 107 is first of all pressed into its lower position by ribs or pressure elements 115 of the plug-in part 111. Since the first securing element 107 is still coupled to the second securing element 109 via the coupling elements, a force which is provided by the plug-in part 111 to move the first securing element 107 is transmitted to the second securing element 109 in the case of a movement of the first securing element 107 into the lower position, and the second securing element 109 is moved in the direction of its lower position. Accordingly, the plug-in part 111 can be pushed through the second securing element 109 into a predefined securing position in the main body 103.

As a result of the automatic and coupled movement of the first securing element 107 and the second securing element 109 during plugging of the plug-in part 111 into the main body 103, a manual actuation of the first securing element 107 and the second securing element 109 can be dispensed with.

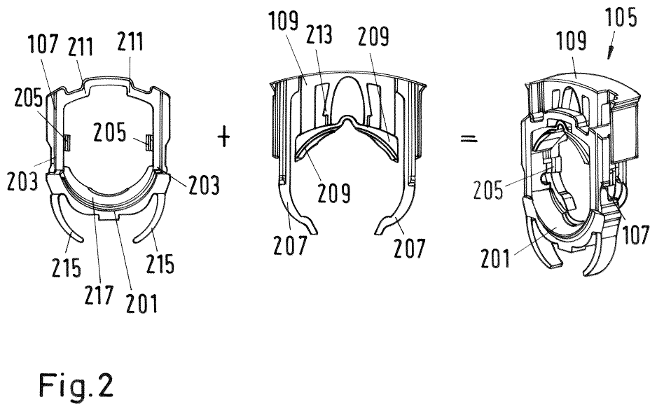

FIG. 2 shows the first securing element 107, the second securing element 109 and the securing system 105 which comprises the first securing element 107 and the second securing element 109.

The first securing element 107 comprises an optionally closed body 201 with arms 203, on each of which a coupling element 205 is arranged. The coupling elements 205 extend parallel to a center axis beyond the closed body 201, in order to engage into arms 207 of the second securing element 109 and to secure the second securing element 109 on the first securing element 107 and to couple it mechanically to the latter.

Accordingly, a movement of the arms 203 of the first securing element 107 or the coupling elements 205 away from one another leads to a free movement of the first securing element 107, with the result that the first securing element 107 can be moved, for example raised, that is to say moved into its upper position, independently of the second securing element 109. To this end, the first securing element 107 comprises optional spring elements 215 which press the first securing element 107 away from the main body 103 when the first securing element 107 is situated in its lower position.

A securing region 217 of the first securing element 107 serves to overlap the receptacle 113 of the connection element 101 when the first securing element 107 is situated in its upper position, with the result that a plug-in element 111 which engages into the receptacle 113 is secured in the connection element 101.

Furthermore, the second securing element 109 comprises transmission elements 209, 213 which engage into transmission receptacles 211 of the first securing element 107 when the second securing element 109 is situated in its upper position or its intermediate position, with the result that pressure on the second securing element 109 leads to a movement of the first securing element 107.

In the present case, the transmission elements 209 comprise hooks 213 configured such that projections of the hooks 213 overlap the transmission receptacles 211 or engage into the latter. To this end, the transmission elements 209, 213 are subjected to a pressure load in the direction of the transmission receptacles 211 via an optional spring element.

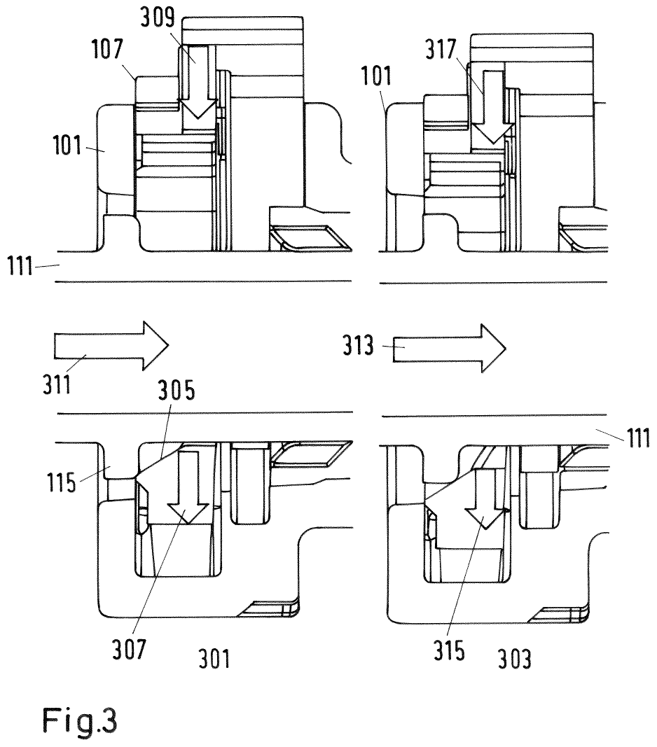

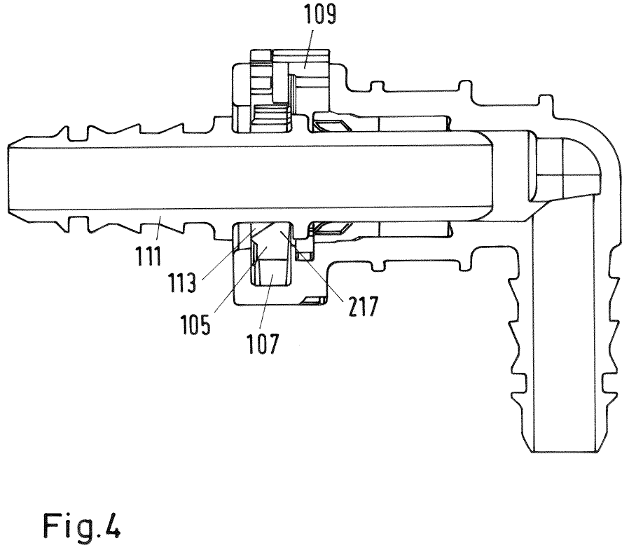

FIG. 3 and FIG. 4 show a connection operation for the connection of the plug-in element 111 to the connection element 101. In a first step 301, the plug-in element 111 is pressed into the main body 103 of the connection element 101, as indicated by arrow 311, with the result that the pressure element 115 presses on a guide 305 in the form of an oblique or slanting plane of the first securing element 107 and moves the first securing element 107 in the direction of its lower position, as indicated by arrow 307.

Since the first securing element 107 is mechanically coupled to the second securing element 109 in the receiving state, the movement of the first securing element 107 in the direction of its lower position is transmitted to the second securing element 109, and the second securing element 109 moves in the direction of its lower position, as indicated by arrow 309.

In a second step 303, the plug-element 111 which can be, for example, a valve of a fluid system is pressed further into the main body 103, as indicated by arrow 313. Here, the pressure element 115 migrates along the guide 305 or the guide 305 migrates along the pressure element 115, with the result that the first securing element 107 is pressed further downward in the direction of its lower position, as indicated by an arrow 315 which is shifted relative to the arrow 307. As a result of the movement of the first securing element 107 into its lower position, the second securing element 109 is also moved further in the direction of its lower position into an intermediate position, in which the plug-in element 111 can be plugged into the second securing element 109, as indicated by an arrow 317 which is shifted relative to the arrow 309.

In FIG. 4, the first securing element 107 is situated in its upper position, and the second securing element 109 is situated in its lower position.

In its upper position, the first securing element 107 overlaps, in particular by way of the securing region 217, the receptacle 113 and, due to this, secures the plug-in element 111 against sliding out of the connection element 101. Accordingly, the securing region 217 is flat on a side which faces the second securing element 109, with the result that sliding of the plug-in element 111 on the securing region 217 and a movement of the plug-in element out of the receptacle 113 are prevented.

In its lower position, the second securing element 109 also overlaps, in particular by way of its transmission elements 209, the receptacle 113 and, due to this, secures the plug-in element 111 against sliding out of the connection element 101.

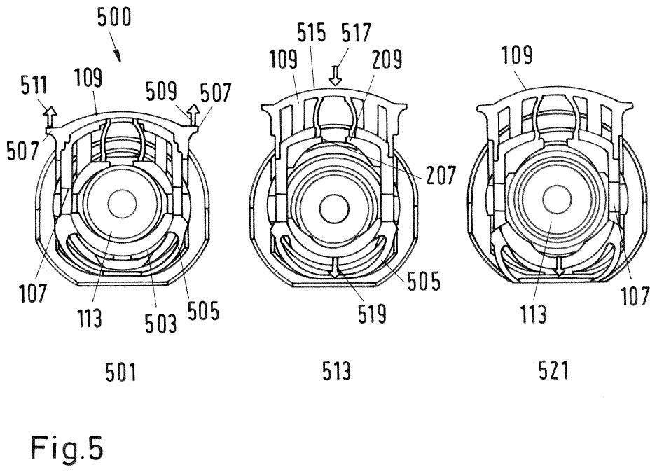

FIG. 5 shows a method 500 for the reversible provision of a fluid-conducting connection.

In a first state or securing state 501, the first securing element 107 is situated in its upper position, and the second securing element 109 is situated in its lower position. Accordingly, the first securing element 107 and the second securing element 109 each overlap the receptacle 113, with the result that a plug-in element (not shown here for reasons of clarity) which is introduced into the receptacle 113 is secured by the first securing element 107 and the second securing element 109 in a main body of a corresponding connection element.

When the first securing element 107 is situated in its upper position and the second securing element 109 is situated in its lower position, locking elements 503 of the second securing element 109 engage into locking element receptacles 505 of the first securing element 107 which prevent an undesired movement of the second securing element 109 into its upper position.

In order to release the plug-in element, the second securing element 109 is pulled at its first user interfaces 57 out of its lower position upward into its upper position, as indicated by arrows 509, 511, as a result of which the locking elements 503 of the second securing element 109 are released from the locking element receptacles 505 of the first securing element 107.

In a second state or transition state 513, the second securing element 109 is situated in its upper position, in which the locking elements 503 of the second securing element 109 are released from the locking element receptacles 505 of the first securing element 107, and transmission elements 207 of the second securing element 109 engage into transmission receptacles 209 of the first securing element 107. Accordingly, a pressure on a second user interface 515 of the second securing element 109, as indicated by arrow 517, brings about a movement of the second securing element 109 into its intermediate position and, due to this, a movement of the first securing element 107 into its lower position.

In a third state or release state 521, the first securing element 107 is situated in its lower position and the second securing element 109 is situated in its intermediate position, with the result that the receptacle 113 is overlapped neither by the first securing element 107 nor by the second securing element 109, and the plug-in element can be removed from the main body 103.

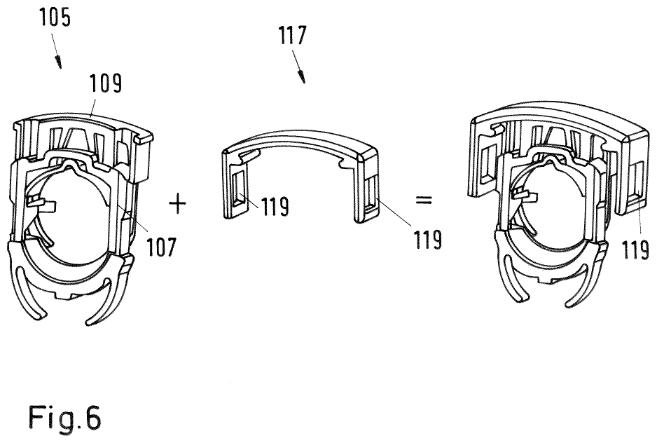

FIG. 6 shows the securing system 105 together with a covering element 117 which comprises two recesses 119 which move together with the second securing element 109 relative to the first securing element 107 or a main body 103 of the connection system 100.

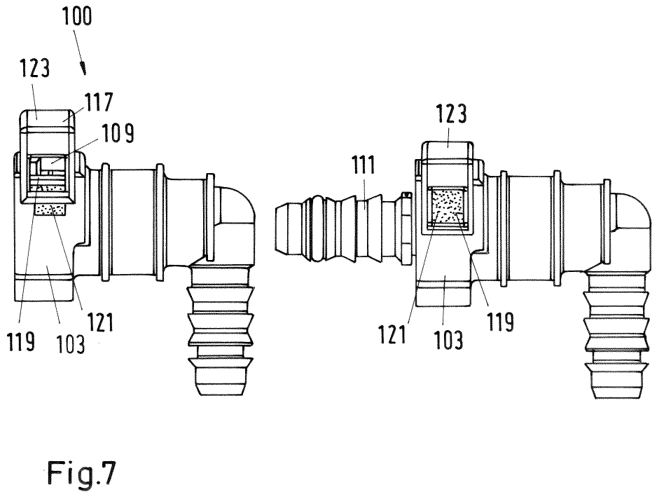

FIG. 7 shows the connection system 100 in a configuration, in which a machine-readable code is shown in display regions 121 on the main body 103.

The display regions 121 are overlapped by a covering body 123 of the covering element 117, with the result that the machine-readable code cannot be read out when the second securing element 109 is situated together with the covering element 117 in its upper position and no plug-in element 111 is introduced into the main body 103.

When a plug-in element 111 is introduced into the main body 103, the plug-in element 111 presses the second securing element 109 together with the covering element 117 into its lower position, with the result that the display regions 121 are overlapped by the recesses 119, and the machine-readable code can be detected or is detectable by machine.

Accordingly, the display regions 121 on the main body 103 and the recesses 119 are oriented relative to one another in such a way that the machine-readable code can be detected by machine only when the second securing element 119 is situated together with the covering element 117 in its lower position, and the plug-in element 111 is secured in the main body 103. Therefore, in the case of a detection of the machine code by, for example, an optical scanner, a secured connection between the plug-in element 111 and the main body 103 can be validated automatically and, for example, a validation message can be generated.

The invention is not restricted to one of the above-described embodiments, but rather can be modified in a wide variety of ways.

All the features and advantages which are apparent from the claims, the description and the drawing, including structural details, spatial arrangements and method steps, can be essential to the invention both per se and in a very wide variety of combinations.

Furthermore, in general, while a multitude of embodiments have been depicted and described with a multitude of components in each embodiment, in alternative embodiments the components of various embodiments could be intermixed, combined, and/or exchanged for one another. In other words, components described in connection with a particular embodiment are not necessarily exclusive to that particular embodiment.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

100 Connection system
101 Connection element
103 Main body
105 Securing system
107 First securing element
109 Second securing element
111 Plug-in element
113 Receptacle
115 Pressure element
117 Covering element
119 Recess
121 Display region
123 Covering body
201 Body
203 Arm
205 Movement element
207 Arm
209 Transmission element
211 Transmission receptacle
215 Spring element
301 First step
303 Second step
305 Guide
307 Arrow
309 Arrow
311 Arrow
313 Arrow
315 Arrow
317 Arrow
500 Method
501 First state
503 Locking element
505 Locking element receptacle
507 First user interface
509 Intermediate position
511 Arrow
517 Arrow
519 Arrow
521 Third state

1. A connection element for the fluid-conducting connection to a plug-in part
wherein the connection element comprises:
a main body
a securing system
wherein the main body comprises a fluid channel and a receptacle for receiving the plug-in part
wherein the securing system is arranged on the main body and is configured to secure the plug-in part in a predefined position relative to the fluid channel in the receptacle in order to provide a fluid-conducting connection between the connection element and the plug-in part
wherein the securing system comprises a first securing element and a second securing element
wherein the first securing element can be moved between a lower position and an upper position,
wherein the second securing element can be moved between an upper position and a lower position,
wherein the second securing element is to be reversibly coupled mechanically to the first securing element via a number of coupling elements wherein the number of coupling elements can be moved between a coupling position and a release position,
wherein, in the coupling position, the number of coupling elements transmit a movement of the first securing element to the second securing element with the result that the first securing element moves the second securing element in the direction of its lower position when, in the case of a movement of the plug-in part along a predefined trajectory through the main body a pressure element of the plug-in part moves the first securing element into its lower position, and the number of coupling elements release a movement of the first securing element into its upper position when the pressure element moves along the predefined trajectory further through the main body into the second securing element

2. The connection element as claimed in claim 1,
wherein the first securing element comprises a number of spring elements which are configured to press the first securing element from its lower position into its upper position.

3. The connection element as claimed in claim 1,
wherein the second securing element can be moved between its upper position, its lower position and an intermediate position when the plug-in part moves through the main body,
wherein the second securing element is situated in its intermediate position between its upper position and its lower position and releases a movement of the plug-in part through the main body.

4. The connection element as claimed in claim 1,
wherein the first securing element comprises adjacent arms which surround the receptacle of the main body, wherein a number of coupling elements are arranged on each of the arms,
wherein the number of coupling elements can be moved between a release position and a coupling position, and the coupling elements are oriented toward one another in their coupling position, and are oriented further away from one another in the release position than in the coupling position,
wherein the second securing element comprises a number of arms which each comprise a receptacle for engagement of a coupling element of the number of coupling elements of the first securing element, with the result that the number of coupling elements block a movement of the second securing element relative to the first securing element when the number of coupling elements are situated in their coupling position, and release a movement of the second securing element relative to the first securing element when the number of coupling elements are situated in their release position.

5. The connection element as claimed in claim 4,
wherein the number of coupling elements overlap the receptacle in their coupling position, with the result that the plug-in part presses the number of coupling elements into their release position when the plug-in part engages into the receptacle.

6. The connection element as claimed in claim 1,
wherein the main body comprises a securing element receptacle for receiving the first securing element in regions,
wherein the first securing element engages in regions into the securing element receptacle in its lower position, in order to release the receptacle of the main body, and overlaps the receptacle in regions in its upper position.

7. The connection element as claimed in claim 1,
wherein the second securing element can be moved between its upper position, an intermediate position and its lower position,
and the second securing element comprises a number of transmission elements which are configured to transmit a pressure force, exerted on the second securing element, to the first securing element when the second securing element moves from its upper position into its intermediate position, in order to move the first securing element from its upper position, in which the first securing element overlaps the receptacle of the main body in regions, into its lower position, in which the first securing element releases the receptacle of the main body.

8. The connection element as claimed in claim 7,
wherein, in its lower position, the second securing element itself overlaps the receptacle of the main body in regions, and locking elements of the second securing element engage into locking element receptacles of the first securing element, in order to secure the first securing element in its lower position,
wherein the second securing element is situated in its intermediate position in a position which is elevated in comparison with the lower position of the second securing element and in which the number of transmission elements of the second securing element engage on the first securing element and the locking elements are released from the locking element receptacles.

9. The connection element as claimed in claim 7,
wherein the second securing element comprises a number of first user interfaces for the manual movement of the second securing element from its lower position into an upper position and a number of user interfaces for the manual movement of the second securing element from its upper position into its intermediate position.

10. The connection element as claimed in claim 1,
wherein a number of recesses are configured in the second securing element, through which recesses a number of display regions which are configured on the main body are visible when the second securing element is situated in its lower position, and
wherein a region, surrounding a respective recess of the second securing element overlaps a respective display region when the second securing element is situated in its upper position.

11. A plug-in part for the fluid-conducting connection to a connection element as claimed in claim 1,
wherein the plug-in part comprises a main body with a channel for conducting fluid and a multiplicity of pressure elements which are arranged on the main body, wherein respective pressure elements are spaced apart from one another in such a way that the first securing element and the second securing element engage between two pressure elements of the multiplicity of pressure elements (115) when the plug-in part is secured in the connection element, and
wherein the plug-in part is configured, in the case of a movement on a predefined trajectory through the main body to move the first securing element of the connection element into its lower position and, due to this, to move the second securing element into its lower position.

12. A connection system for conducting fluid,
wherein the connection system comprises a number of connection elements as claimed in claim 1.

13. A method for the reversible provision of a fluid-conducting connection,
wherein the connection method comprises:
providing the connection system as claimed in claim 12,
introducing a respective plug-in part into a receptacle of a respective connection element of the connection system, as a result of which the plug-in part in the connection element first of all presses the first securing element into its lower position and, due to a reversible mechanical coupling of the first securing element to the second securing element, presses the second securing element into its lower position, and, on its trajectory through the connection element, the plug-in part releases the reversible mechanical coupling, with the result that the first securing element moves into its upper position on account of a spring force which is provided by spring elements of the first securing element, while the second securing element remains in its lower position,
wherein the first securing element overlaps the receptacle in regions in its upper position, and the second securing element overlaps the receptacle in regions in its lower position, in order to secure the plug-in part in the connection element.

14. The method as claimed in claim 13,
wherein the method comprises, furthermore:
moving the second securing element into its upper position, and
moving the second securing element out of its upper position into its intermediate position in the direction of the main body, with the result that the first securing element is pressed into its lower position via a number of transmission elements of the second securing element, without the second securing element overlapping the receptacle of the main body.

15. A covering element for selectively covering a display region on a main body of a connection element as claimed in claim 1,
wherein the covering element comprises:
a covering body,
an interface for mechanical coupling to the second securing element of the connection element,
a number of recesses which are configured in the covering body,
wherein the covering element is configured to also move in the case of a movement of the second securing element with the result that, when the second securing element is situated in its lower position, display regions which are configured on the main body can be detected by machine, and
the covering body overlaps a respective display region of the main body when the second securing element is situated in its upper position.

16. A connection system for conducting fluid,
wherein the connection system comprises a number of plug-in parts as claimed in claim 10.
